(19) United States
(12) Patent Application Publication
(10) Pub. No.: US 2007/0127597 A1
(43) Pub. Date: Jun. 7, 2007

(54) System and method for facilitating visual comparison of incoming data with existing data

(75) Inventors: Mary J. Ammer, Roseville, MN (US); Deborah J. Belcher, Hinesburg, VT (US)

Correspondence Address: ANDRUS, SCEALES, STARKE & SAWALL, LLP, 100 EAST WISCONSIN AVENUE, SUITE 1100, MILWAUKEE, WI, 53202, US

(73) Assignee: IDX Investment Corporation, S. Burlington, VT (US)

(21) Appl. No.: 11/292,176

(22) Filed: Dec. 1, 2005

(51) Int. Cl. H04L 27/00

(52) U.S. Cl. 375/324

(57) ABSTRACT

A data compare and update system (104) that includes a compare/update module (208) that displays a compare/update GUI (500) that allows a user to visually compare incoming data (116) coming into the system to existing target data (108). The compare/update module can be configured to flag variant data within the incoming data relative to the target data and to allow the user to select which, if any, target data to update with the variant data. The system also includes a data match module (208) that allows a user to validate appropriateness of data being compared and to select which incoming data fields to utilize in retrieving the appropriate target data fields for use in the visual comparison. The system contains features that allow a user to configure the system to recognize incoming data of various types and formats.

### FIELD OF THE INVENTION

The present invention generally relates to the field of information systems. In particular, the present invention is directed to a system and method for facilitating visual comparison of incoming data with existing data.

### BACKGROUND OF THE INVENTION

Current systems for transferring data into existing electronic databases do not allow users to easily visually compare incoming data to existing data in order to select data to update. A great deal of human intervention is now required to determine how to use incoming data that is not a complete and automated update to the existing data. Such intervention can be very time consuming and may require use of manual data entry techniques. Even though automated matching techniques may be used in attempt to determine if one or more data fields should be updated, in many cases the best data matchers are an organization's human data users. A human can intuitively draw conclusions in a very reliable fashion by looking at the data. They do not need to do extensive data research or use complex algorithms; they simply use past experience and knowledge to make the right decision.

In the current state of the art, if a user of an existing electronic database would like to use incoming information to update existing data, a mapping process that uses logical rules may be used to predetermine the disposition of the data. However, an opportunity is not given to the end user to review the data prior to updating so that the user may make a different selection for a particular data field if necessary. Instead, a manual list of incoming data values that do not meet a specific criterion for disposition, i.e., “variant data,” will often be created, and this list will need to be reviewed.

Oftentimes, review of such a manual list may involve an organization's staff member performing a manual look-up to the existing data so as to compare the variant data to the existing data and then make a determination of how the variant data should be used, if at all. This determination would then be manually notated, and a subsequent manual data entry step would be used to update existing data or to create new data fields or new data records to hold the variant data if the variant data does not yet exist in the existing electronic database but it is desired that it be there.

In addition, in many databases, e.g., healthcare databases, there is a need to have a wide variety of criteria available for matching incoming data to existing data. Current healthcare enterprise systems and applications often have very limited matching capabilities and will only allow a match to take place based on a predetermined patient identifier, e.g., patient name or unique medical record number, among others. Furthermore, the incoming data may be received in a variety of transactional formats, such as various versions of HL7 and ANSI X12 as well as formats of a more proprietary nature. For each type of format and transaction, there is very little current ability to indicate which data fields should be considered matching fields to the existing healthcare system and how that matching will take place. There is also the need to have the most current information that can have an impact on both the finances of the healthcare organization and on the health of the patients. By expediting the updating process, providers and staff at healthcare organizations will have access to the most up-to-date data.

### SUMMARY OF THE INVENTION

In one aspect, the present invention is directed to a method of facilitating visual comparison of a plurality of incoming data values with a plurality of target data values. The plurality of incoming data values are respectively associated with a plurality of incoming data fields, and the plurality of target data values are respectively associated with a plurality of target data fields and stored in at least one target datastore. The method comprises receiving via a first user interface a selection of at least one incoming data field of the plurality of incoming data fields. The plurality of target data values are retrieved from the at least one target datastore as a function of the at least one incoming data field selected. The plurality of target data values and the plurality of incoming data values are displayed simultaneously with one another on a display so as to facilitate visual comparison of the plurality of target data values and the plurality of incoming data values.

In another aspect, the present invention is directed to a system facilitating visual comparison of a plurality of incoming data values to a corresponding respective plurality of target data values. The plurality of incoming data values are associated respectively with a plurality of incoming data fields, and the plurality of target data values are associated respectively with a plurality of target data fields. The system comprises a first means for displaying the plurality of target data values and the plurality of incoming data values substantially side-by-side so as to facilitate visual comparison of like ones of the plurality of incoming data values and the plurality of target data values. A second means is provided for allowing a user to select at least one of the plurality of incoming data fields and for utilizing the selected one of the plurality of incoming data fields to retrieve the plurality of target data values.

### BRIEF DESCRIPTION OF THE DRAWINGS

For the purpose of illustrating the invention, the drawings show a form of the invention that is presently preferred. However, it should be understood that the present invention is not limited to the precise arrangements and instrumentalities shown in the drawings, wherein:

FIG. 1A is a high-level schematic diagram illustrating a system containing a data compare and update system of the present invention; FIG. 1B is a high-level schematic diagram of an operating environment in which the systems of FIG. 1A may be implemented;

FIG. 2 is a high-level schematic diagram of the data compare and update system of FIG. 1A;

FIG. 3 is a screenshot of an Accepted Message Format Setup homescreen of the data compare and update system of FIGS. 1A and 2;

FIG. 4A is a screenshot of a Message Setup homescreen of the data compare and update system of FIGS. 1A and 2; FIG. 4B is a screenshot of a Data Match Setup screen of the data compare and update system of FIGS. 1A and 2; FIG. 4C is a screenshot of a Data Crossmap screen of the data compare and update system of FIGS. 1A and 2; FIG. 4D is a screenshot of a Crossmap Definition window of the data compare and update system of FIGS. 1A and 2;

FIG. 5 is a screenshot of a COMPARE/UPDATE screen of the data compare and update system of FIGS. 1A and 2; and

FIGS. 6A-B show a flow diagram illustrating a data compare and update method of the present invention that may be implemented by data compare and update system of FIGS. 1A and 2.

### DETAILED DESCRIPTION

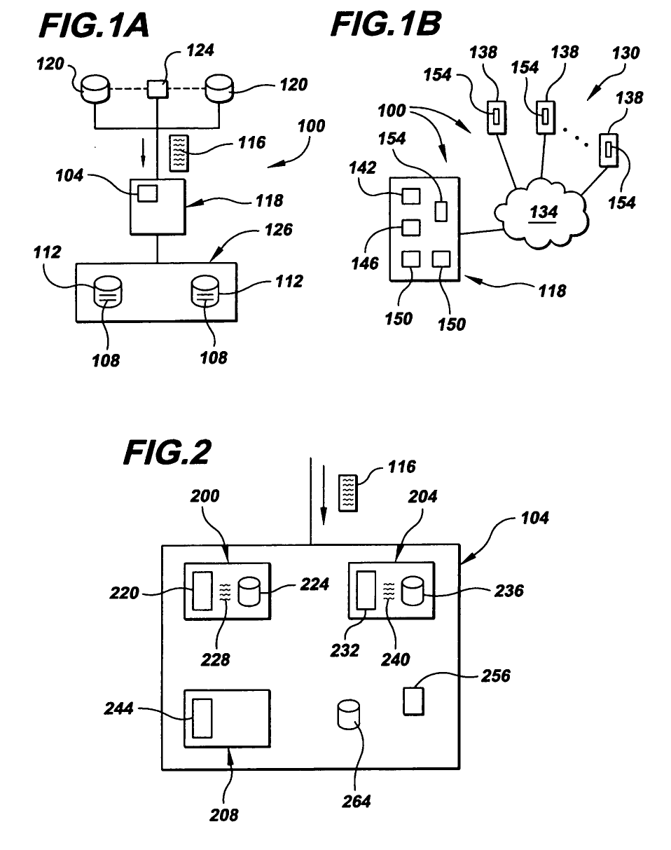

Referring now to the drawings, FIG. 1A illustrates a system 100 that includes a data compare and update (DCU) system 104 of the present invention. Generally, DCU system 104 permits a user (not shown) to visually verify and manually initiate automated updating of target data 108 contained in one or more target datastores 112 based on incoming data 116 coming into the DCU system. (It is noted that the terms “updating,” “update” and variations thereof as they are used herein and in the appended claims include the replacement of particular data values of target data 108 with particular data values of incoming data 116, population of as-yet unpopulated existing target data fields, records, etc., with corresponding respective incoming data values, and creation and population of new target data fields with corresponding respective incoming data values.)

DCU system 104 may be implemented in any suitable computer 118, e.g., a general purpose computer, an application specific computer, a server, etc. Broadly, incoming data 116 may be virtually any data that is not target data 108. Typically, incoming data 116 is received by DCU system 104 from a source other than datastores 112. Examples of such sources of incoming data 116 include, but are not limited to, foreign datastores, such as foreign datastores 120, and/or software applications, such as software application 124 that essentially assembles the incoming data from data stored in one or more datastores and/or from ephemeral data not stored in a datastore in a conventional sense. That said, those skilled in the art will readily appreciate that incoming data 116 may indeed be stored in datastore 112 along with target data 108. It is also noted that each target datastore 112 need not necessarily reside in any single storage device 126 as depicted in FIG. 1A, but rather may be distributed among two or more storage devices, examples of which include various types of long-term storage devices, e.g., magnetic disks, optical disks, magnetic tape, nonvolatile memory, etc. and short-term storage devices, e.g., volatile random access memory, among others.

FIG. 1B illustrates an example of an environment 130 in which system 100 of the present invention may be implemented. Although not required, the invention will be described generally in terms of computer-executable instructions, such as program modules, that are executed by a conventional, general purpose, digital computer. Typically, program modules include routines, programs, objects, components, data structures, etc. that perform specific tasks. The invention may be practiced with a variety of computer system configurations, including networked client-server computing systems, hand-held devices, programmable consumer electronics, minicomputers, mainframe computers, and the like. The invention will typically, but not necessarily, be practiced in distributed computing environments where tasks are performed by remote processing devices that are linked through a communications network, e.g. a LAN, WAN or an Internet-based network. In a distributed computing environment, program modules may be located in both local and remote memory storage devices.

In addition, it is contemplated that system 100 may, but need not necessarily, operate in networked computing environment 130 in which computer 118 is connected, directly or indirectly via a network 134 (e.g., a LAN, WAN, Internet, or combination thereof), to one or more network servers 138. In some cases, a computer 118 may include multiple computers 118 operably connected via a LAN, WAN, the Internet or combination thereof (not shown). Computer 118 may include one or more computer central processing units 142, a computer memory 146, and input/output devices 150. Environment 130 and components thereof include computer programs 154, which, when executed by computing resources within the environment provide the functionality of the present invention.

As discussed below in detail, DCU system 104 may be configured to handle incoming data 116 that is in any one of a number of data formats and that is of any one or more message types. Although the broad concepts of data format and message types are illustrated below using an example directed to the healthcare industry, those skilled in the art will readily recognize that the present invention may be implemented in virtually any industry or field in which it is advantageous or desired to enable computer-implemented manual data verification and manual initiation of updating of target data 108 based on incoming data 116. Examples of applications of a DCU system of the present invention include banking, credit reporting, inventory control in virtually any business that adds and subtracts items, human resources, e.g., for use between systems such as time reporting, payroll and employee databases and/or for use with handling employee benefits, such as health care, life and disability insurance, etc. The preceding list is, of course, exemplary and not limiting. Those skilled in the art will readily appreciate that the applications of the present invention are too many to present an exhaustive list. It will be apparent that the kind of data, e.g., scientific, demographic, geographic, financial, business transactional, etc., contemplated to be handled by the present invention is likewise broad.

Examples of data formats used in the healthcare industry include, among others, the X12 uniform standard format promulgated by the Accredited Standards Committee (ASC) of the American National Standards Institute (ANSI) for business-to-business transactions (www.x12.org), the HL7 uniform standard format promulgated by the Health Level Seven Standards Developing Organization (SDO) of ANSI for healthcare domain transactions (www.h17.org), and various proprietary/custom formats devised by software companies and other entities.

Briefly, the ASC X12 standard provides more than 315 standard electronic data interchange (EDI) truncations that enable secure B2B e-commerce messaging in a variety of fields, including insurance, finance government, supply chain, transportation, technical assessment, communications/controls, and education administration. Generally, each transaction provides a pre-formatted structure that allows businesses or other entities to communicate particular transactional information to each other. Each standard transaction may be implemented in any one of a variety of fields, e.g., health care, banking, life insurance, etc., in accordance with an “implementation guide” (IG) specific to that field. For example, in the healthcare context, the ASC X12 standard provides as standard transaction number 278 a healthcare insurance transaction set for “health care service review infromation.” One of the 278 IGs defines this transaction for requesting and receiving approval from a healthcare insurer for patient referrals in order to ensure that a referred service is covered by the insurer prior to the performance of the service. Another IG for the 278 transaction is used for inquiries about the status of a referral. As another example, there are multiple IGs for various implementations of the 837 claim submission transaction, including IGs for professional, institutional, pharmacy and dental claims, among others. Generally, utilizations of EDI transactions and their implementations are often referred to by the ordinal numerals of the ASC X12 transaction. Thus, utilization of an implementation of the healthcare service review information transaction is commonly referred to as a “278 transaction.” Other examples of ASC X12 EDI transactions relevant to healthcare are listed in Table I below. It is noted that this table is not exhaustive, but merely illustrative. These are examples that are the standard versions of each of these transactions.

TABLE I
Exemplary Healthcare-Related ASC X12 Transactions

| Transaction Number | Transaction Name |
|---|---|
| 270 | Health Care Eligibility/Benefits Inquiry |
| 271 | Health Care Eligibility/Benefits Information |
| 275 | Patient Information |
| 276 | Health Care Claim Status Request |
| 277 | Health Care Claim Status Notification |
| 278 | Health Care Service Review Information |
| 820 | Payment Order Remittance Advice |
| 834 | Benefit Enrollment and Maintenance |
| 835 | Health Care Claim Payment/Advice |
| 837 | Health Care Claim |

As mentioned above, DCU system 104 may be configured to handle one or more message types. In the context of incoming data 116, the message type(s) correspond(s) to the purposes(s), use(s) or function(s) of the incoming data or reason(s) for the incoming data. For example, in the healthcare context, target data 108 may include a plurality of patient records each parsed into a variety of fields, such as a medical record number field, patient name field, date of birth field, gender field, and a number of fields relating to referrals the corresponding patient has received. The referrals fields may include, among others, a status field for each referral for containing a data value, e.g., pended, approved, denied, etc., that indicates the status of that referral.

In one example, incoming data 116 may be an ASC X12 278 transaction from an insurer that contains a certification of a particular referral for a certain patient. In this case, the purpose of or reason for incoming data 116 is to notify a healthcare provider that the insurer has approved the referral. In addition, a use of incoming data 116 is to update the status of the referral for the patient at issue, in this case to “approved.” Consequently, a suitable message type for this transaction may be called “referral,” or similarly descriptive term. Examples of other message types for implementations of other ASC X12 transactions listed in Table I may be as set forth below in Table II. It is noted here that in addition to the status of “approved,” the 278 transaction will include other data relating to the patient at issue, e.g., name, date of birth, insurance contract number, certification number, etc. that uniquely identify the patient and the transaction. As discussed below, DCU system 104 may be user-configurable to highlight any variant data in incoming data 116 relative to target data 108 and to permit a user to manually select whether or not the target data should be updated with any of the variant data. Table II shows examples of the data that would be changed or added to a receiver's receiving system when the receiver is a provider and the sender is a health plan. Table III shows examples of the data that would be changed or added to the payer's receiving system when the receiver is a payer and the sender is either an employer or a provider.

TABLE II
Exemplary Message Types for ASC X12 Transactions in Table I
Provider is receiving the data from a Payer

| Transaction | | |
|---|---|---|
| No. | Transaction Name | Message Type |
| 271 | Health Care Eligibility Benefits | Eligibility |
| | Response | Verification |
| 277 | Health Care Claim Status Response | Claim Status |
| | | Response |
| 835 | Health Care Claim Payment/Advice | Claim Payment |
| 278 | Health Care Service Review | Referral Approval |
| | Information - Request Response | Status |

TABLE III
Exemplary Message Types for ASC X12 Transactions in Table I
Payer is receiving the data from an Employer or Provider

| Transaction | | |
|---|---|---|
| Set No. | Transaction Name | Message Type |
| 820 | Payment Order Remittance Advice | Premium Payment |
| 834 | Benefit Enrollment and Maintenance | Benefit Enrollment |
| 837 | Health Care Claim | Claim Submission |
| | | (from a provider) |

HL7 messages are clinical in nature, so the sender and receivers are typically both healthcare provider systems. Message examples would be the sending of lab results from a laboratory computer system to a clinical record computer system within the same hospital. Or that message could be sent from the laboratory computer system to a physician's office computer system that is not part of the hospital's information system. The HL7 uniform standard for healthcare domain messaging has a structure generally parallel to the structure of the ASC X12 standard. That is, the HL7 uniform standard has a particular format that is common across a variety of message types, much in the same way that the ASC X12 standard has a particular format that is common across a variety of transactions. For example, the HL7 uniform standard may be used to create a variety of templates or data “models.” Generally, a template is a structured collection of data/information that is of interest to one or more healthcare stakeholders. Each template may be considered to correspond to a respective message type in the manner that ASC X12 transaction implementations each correspond to a respective message type. On the other hand, a data model is similar to “implementations” in the ASC X12 constructs. That is, HL7 data model are used to define the uniform standard for particular applications. Examples of HL7 templates and data models, or simply “messages,” and corresponding message types are listed in the following Table III. Those skilled in the art will readily understand that the list of HL7 messages in Table III is merely illustrative and not exhaustive.

TABLE IV
Exemplary HL7 Messages and Message Types

| Message | Message Type |
|---|---|
| Lab Result | Blood Lab |
| DiabTemp | Diabetes Template |
| DeprTemp | Depression Template |
| Biopsy | Tissue Biopsy |

It is recognized that the foregoing examples of format and message types of incoming data 116 relative to the ASC X12 and HL7 standards are specialized and are likely to change over time. However, those skilled in the art will readily appreciate that the broad concepts of data format and message type described above relative to these specific examples are applicable to many other data messaging/communication standards across a wide array of fields, and that these concepts will most likely be applicable in any future versions of the ASC X12 and HL7 standards and other data messaging/communication standards. In addition to being configurable to handle incoming data 116 communicated in accordance with virtually any data standard, DCU system 104 may also be configured to handle incoming data of virtually any proprietary structure.

FIG. 2 illustrates DCU system 104 of FIG. 1A in more detail. In FIG. 2 it is shown that DCU system 104 may comprise a number of “modules” 200, 204, 208 that each provide one or more functions desirable for achieving the overall functionality of the system. In this connection, it is noted that the term “module” is used herein and in the appended claims to indicate a logical grouping of one or more related functions and not necessarily a discrete physical structure that provides such functionality. Indeed, in the most likely instantiations of a DCU system of the present invention, the function(s) of the various “modules” will not be embodied in discrete physical structures, but rather computer-executable instructions, e.g., software, that are executed by one or more processors at the appropriate time in a suitable computer system so as to perform the functions. That said, it is conceivable that the modules of the present invention may be embodied in discrete physical structures, e.g., electronic modules, each of which is capable of performing the corresponding respective function(s). Such computer-executable instructions may be contained in any suitable computer readable medium or combination of media, including, but not limited to, volatile and nonvolatile memory, digital or analog signals or storage devices such as magnetic and optical devices and punch cards, to name just a few.

Referring to FIG. 2, DCU system 104 may comprise a message identification (ID) module 200, a data match module 204, and a compare/update (C/U) module 208. At a high level, message ID module 200 may be designed to provide functionality that allows a user to configure DCU system 104 to recognize and distinguish one or more transaction or message formats based on suitable recognition criteria, e.g., a filename extension and/or identifying indicia accompanying incoming data 116. In this connection, it is noted that incoming data 116 may come into DCU system 104 in any of several ways, most notably as one or more discrete files or one or more streamed files. Message ID module 200 may also be designed to allow a user to configure the communication method by which incoming data 116, i.e., a particular message, is received by DCU system 104. For example, the communication method may be direct via a certain communications port, via an Internet connection, by file transport protocol (FTP), etc. The communication method of each message that a user may desire DCU system 104 to handle will typically be known.

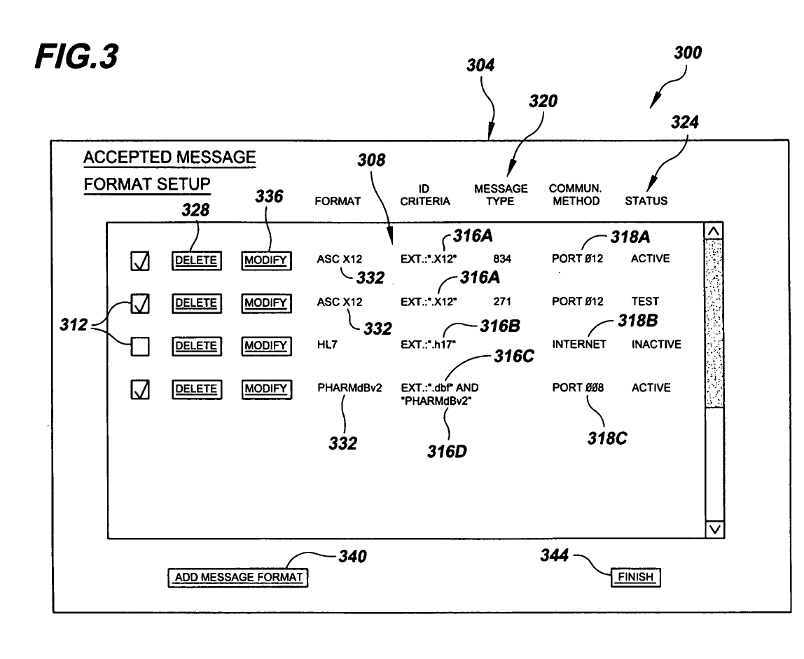

Message ID module 200 may include an ID setup manager 220 that provides a user interface, e.g., ID setup user interface (GUI) 300 of FIG. 3, that allows a user to, among other things: 1) select one or more message formats for DCU system 104 to recognize; 2) configure the message ID module to recognize one or more message formats not already recognizable by the message ID module; 3) modify the recognition (identification) criteria of one or more of the message formats already represented in the ID setup manager; 4) delete one or more message formats already represented in the data format ID module; and 5) configure the communication method for each message format. Generally, ID setup manager 220 is used to build a library 224 (FIG. 2) of message types and corresponding communication methods that one or more users desire DCU system 104 to recognize and handle.

FIG. 3 particularly illustrates an Accepted Message Formats Setup homescreen 304 of ID setup GUI 300, i.e., the first screen displayed by ID setup manager 220 upon each initial activation of the GUI. In a World Wide Web based implementation of DCU system 104 (FIGS. 1A and 2), homescreen 304 may be referred to as the “homepage” of format ID GUI 300 to be consistent with the appropriate terminology. While ID setup GUI 300 and other GUIs described below are illustrated as largely being full-screen GUIs, those skilled in the art will readily appreciate that any one or more of these GUIs may be implemented in other ways, such as popup windows, dialog boxes, etc., to suit a particular design. In addition, while ID setup GUI 300 and other GUIs described below are shown and described as having particular layouts and specific feature types, e.g., checkboxes, buttons, hyperlinks, etc., those skilled in the art should understand that these layouts and feature types are illustrative and not limiting. Where practical, one or more alternatives to the layouts and feature types shown are mentioned. Even so, however, it should be readily apparent to skilled artisans that there are many more unmentioned alternatives for message format and feature types that are well-known in the art of GUI design that could readily be substituted in ID setup GUI 300 and other GUIs shown and described herein.

Accepted Message Format Setup homescreen 304 may present a message format list 308 containing the message formats that DCU system 104 (FIGS. 1A and 2) is presently set up to recognize. As mentioned above, data regarding message format list 308 may be stored in library 224, which may or may not reside on the same storage device 126 as target data 108 (FIG. 1A). In the illustrated case, message ID module 200 is set up to recognize ASC X12 and HL7 standard formats, as well as a proprietary format called “PHARMdBv2,” which is a fictitious proprietary format for communicating prescription data from a proprietary inventory computer application for tracking and maintaining pharmacy data for an in-hospital pharmacy. For the sake of illustration, the PHARMdBv2 message format utilizes a conventional “.dbf” data file format and includes a header that includes “PHARMdBv2” to identify the data as being of the “PHARMdBv2” type. ID setup homescreen 304 may also include one or more selectors, e.g., checkboxes 312, that allow a user to indicate which one or more data formats to enable for a particular application of DCU system 104. In the illustrated case, DCU system 104 is configured, as indicated by the presence or not of checkmarks in checkboxes 312, to recognize the ASC X12 and PHARMdBv2 formats, but not the HL7 format.

Message ID module 200 (FIG. 2) may include rules 228 for handling intentionally unrecognized message formats, i.e., message formats displayed on Message Format Setup homescreen 304 but not selected, and unrecognizable formats, i.e., formats not displayed on the homescreen. For example, a rule for an intentionally unrecognized format may cause message ID module 200 to display a popup window (not shown) that displays the message “The system has received HL7 data that has intentionally been blocked from the system. You may: (1) view this data by selecting the ‘View’ button below; (2) allow the system to recognize this data by changing the recognition status by selecting the “Change Status” button below; or (3) ignore this data by selecting the ‘Ignore’ button below,” or the like. Correspondingly, DCU system 104 may buffer the intentionally unrecognized incoming data. As another example, a rule for an unrecognizable format may cause message ID module 200 to display an alternative popup window (not shown) that displays the message “The system has received unrecognizable data. You may view this data by selecting the ‘View’ button below or ignore this data by selecting the ‘Ignore’ button below,” or the like. A user may choose to change the status of a particular format or add a new format, as the case may be.

Message format list 308 may include for each message format listed the ID criteria 316A-C that message ID module 200 uses to identify the format of incoming message 116 (FIGS. 1A and 2) to the recognizable formats in the message format list. In the illustrated example, ID criteria 316A-B for the ASC X12 and HL7 formats are simply the file extensions “.x12” and “.h17.” However, ID criteria 316C for the PHARMdBv2 format includes the “.dbf” file extension and the item “PHARMdBv2” that appears in the file header of such a file. ID criteria 316A-C may be stored in library 224 (FIG. 2). Each message format listed may also have indicated in a “Message Type” column 320 which message types are valid within a message format. For example, the ASC X12 format may have valid message types such as 270, 271 and 834. FIG. 3 illustrates ASC X12 message types 834 and 271 in use within DCU system 104 (FIGS. 1A and 2). Each message type listed may also include a corresponding communication method indicator 318, e.g. 318A-C as shown, that identifies to the user and DCU system 104 (FIGS. 1A and 2) the communication method by which the system will receive that message type. Communications methods may include various port numbers for TCIP connections, Web addresses such as URLs for Internet connections or dial up numbers for modem connections. Method indicators 318A-C and appropriate machine-level instructions for handling the indicated communication methods may be stored in library 224. A status column 324 may be provided to indicate the activity level or current use stage of each message type. In the present example, the status of a message type can be “Active,” “Inactive,” or “Test.”, with “Active” meaning that the message is currently in operation, “Inactive” meaning that the message type is not being used and “Test” meaning that the message type in either being set-up or is being used for test transactions and not in live active mode.

Message Format Setup homescreen 304 may include a delete feature for selectively deleting each message format from message format list 308. The delete feature may include a “Delete” button 328 (or hyperlink, etc.) that may, upon selection by a user, display a popup window (not shown) asking the user to confirm the deletion. Message Format Setup homescreen 304 may also include a modify feature for selectively modifying the message format identifier 332, the corresponding ID criteria 316A-C, and/or the corresponding method indicator 318A-C. The modify feature may include a “Modify” button 336 (or hyperlink, etc.) that may, upon selection by a user, display a popup window (or another screen/page, etc.) (not shown) that allows the user to modify the data in an appropriate manner. Message Format Setup homescreen 304 may further include an add feature for adding a message format to format list 308. Such add feature may include an “Add Message Format” button 340 (or hyperlink, etc.) that may, upon selection by a user, display a popup window (or another screen/page, etc.) (not shown) that allows the user to add a new message format identifier 332, appropriate ID criteria 316, and appropriate communication method identifier 318. After a user is done with ID setup manager 220 (FIG. 2), the user may select an appropriate selector, e.g., “Finish” button 344, that closes ID setup GUI 300.

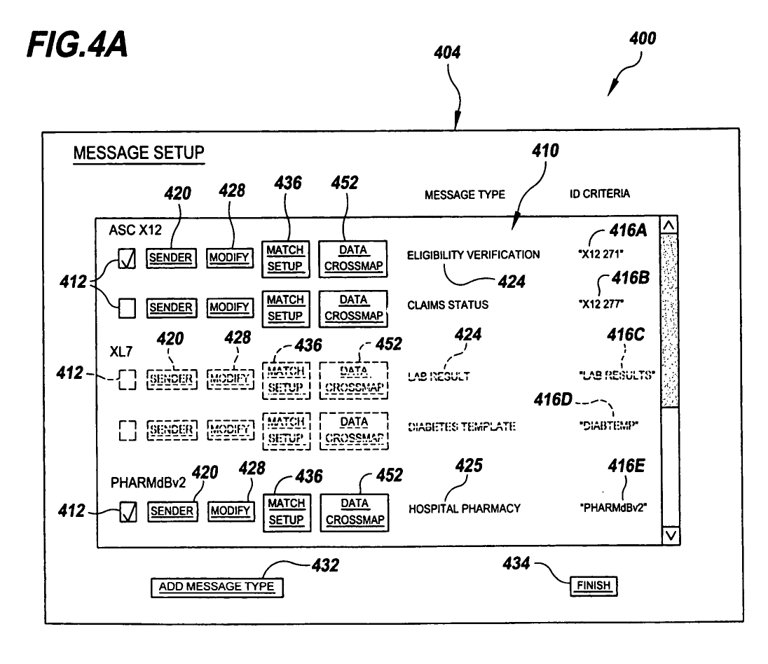

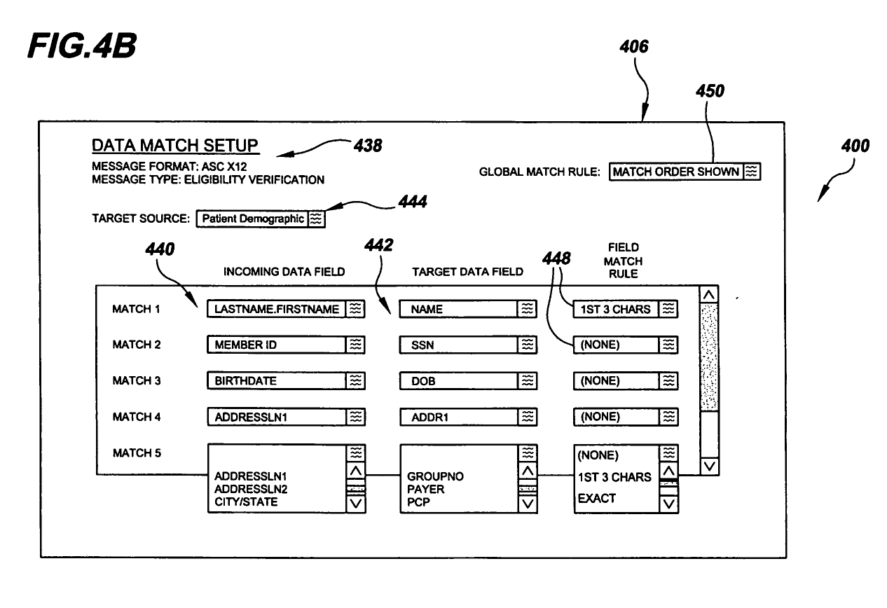

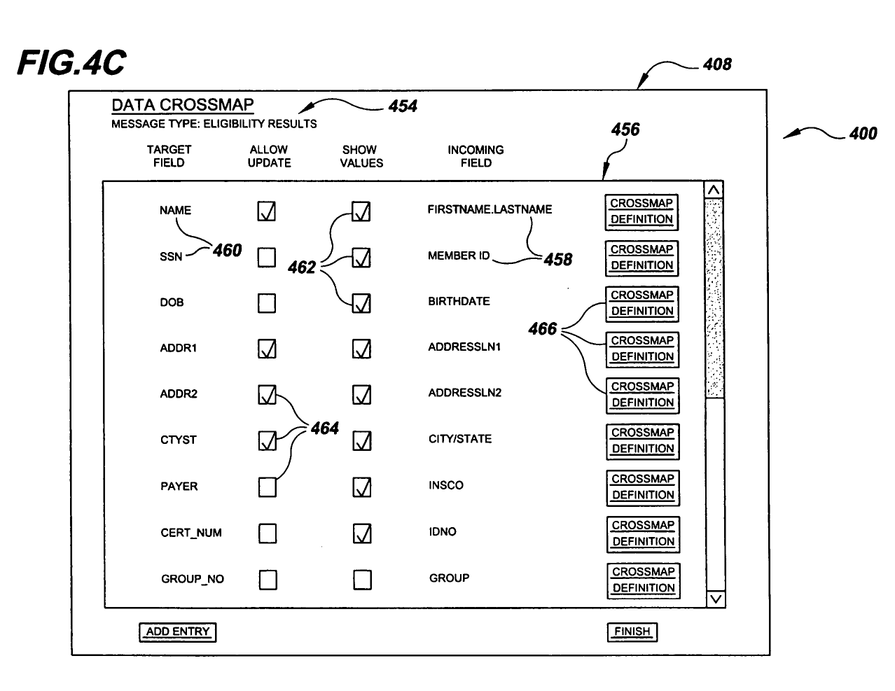

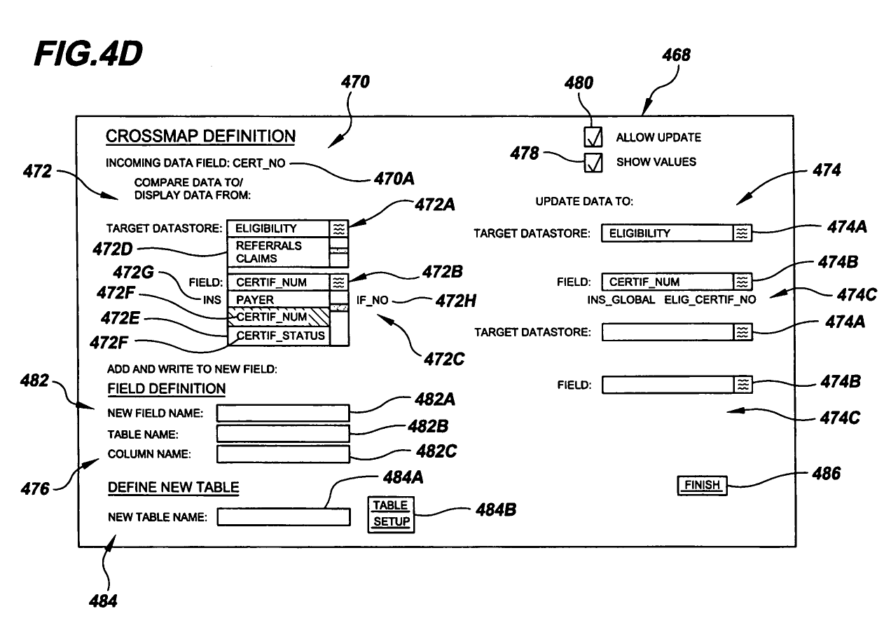

Data match module 204 (FIG. 2) may include a data match manager 232 that provides a user interface, e.g., message setup GUI 400 of FIGS. 4A-D, that allows a user to, among other things: 1) select one or more message types for DCU system 104 (FIGS. 1A and 2) to recognize; 2) configure the message match module to recognize one or more message types not already recognizable by the module; 3) modify the recognition criteria of one or more of the message types already represented in the message match manager; 4) delete one or more message types already represented in the message match module; 5) select one or more data fields of incoming data 116 (FIGS. 1A and 2) for matching the incoming data to the appropriate target data 108; and 6) select the data fields of the incoming data to display for providing the compare and update functionality described above and below. In the present embodiment, the immediately preceding functions 1-4 are provided by a “Message Setup” homescreen 404 (FIG. 4A), function 5 is provided by a “Data Match Setup” screen 406 (FIG. 4B), and function 6 is provided by via “Data Crossmap” screen 408 FIG. 4C). Each of these screens 404, 406, 408 is described below. Of course, those skilled in the art will readily appreciate that message setup GUI may be embodied in many ways other than screens 404, 406, 408. Message Setup homescreen 404, Data Match Setup screen 406, and Data Crossmap screen 408 are described below in detail.

Message Setup homescreen 404, illustrated in FIG. 4A may present a message type list 410 containing the message type(s) for each message format appearing on message format list 308 (FIG. 3) of ID setup GUI 300. Data regarding message type list 410 may be stored in an appropriate datastore, such as data type datastore 236 (FIG. 2), which may or may not reside on the same storage device 126 as target data 108 (FIG. 1A). In the present example, message type setup module 204 is set up to recognize data types “Eligibility Verification” and “Claim Status” for the ACS X12 format, data types “Lab Result” and “Diabetes Template” for the HL7 format, and data type “Hospital Pharmacy” for the PHARMdBv2 format. In this example, it is noted that the Lab Result and Diabetes Template data types under the HL7 format are “grayed out” to indicate that they are not active, as indicated by the lack of a checkmark in the corresponding checkbox 312 in Message Format Setup homescreen 304 of FIG. 3. Message Setup homescreen 404 may also include one or more selectors, e.g., checkboxes 412, that allow a user to indicate which one or more data types to enable for a particular application of DCU system 104. In the present example, DCU system 104 is configured, as indicated by the presence or not of checkmarks in checkboxes 412, to recognize the Eligibility Verification data type of the ASC X12 format, the Lab Result and Diabetes Template data types of the HL7 format (however, recall that the HL7 format is inactive) and the Hospital Pharmacy data types of the PHARMdBv2 format.

Message setup module 204 (FIG. 2) may include rules 240 (FIG. 2) for handling intentionally unrecognized data types, i.e., types contained in the message setup module but not selected, and unrecognizable types, i.e., types not contained in the module. For example, a rule for an intentionally unrecognized data type may cause data match module 204 to display a popup window (not shown) that displays the message “The system has received HL7 Lab Result data that has intentionally been blocked from the system. You may: (1) view this data by selecting the ‘View’ button below; (2) allow this data by selecting the ‘Allow Data’ button below; or (3) ignore this data by selecting the ‘Ignore’ button below,” or the like. Correspondingly, DCU system 104 may buffer the intentionally unrecognized incoming data. As another example, a rule for an unrecognizable format may cause data match module 204 to display an alternative popup window (not shown) that displays the message “The system has received unrecognizable data. You may view this data by selecting the ‘View’ button below or ignore this data by selecting the ‘Ignore’ button below,” or the like. A user may choose to change the status of a particular data type or add a new data type, as the case may be.

Message type list 410 may include for each message format listed the ID criteria 416A-E that data match module 204 uses to match the type of incoming message 116 (FIGS. 1A and 2) to the recognizable types appearing in the message type list. In the illustrated example, ID criteria 416A-B for the ASC X12 Eligibility Verification and Claim Status message types are the transaction numerals of the corresponding ASC X12 transactions (see Table I, above), in this case “X12 271” and “X12 277,” respectively. These identifiers would typically be found in the bodies of files containing such transactions, i.e., message types. Similarly, ID criteria 416C-D for the HL7 Lab Result and Diabetes Template may be the identifiers “HL7 Lab Result” and “HL7 Diabetes Template” that would similarly typically be present in the bodies of files containing such message types. ID criteria 416E may be the identifier “PHARMdBv2” present in the header of a corresponding “.dbf” file containing such message type.

Messages that have been designated as valid for a particular format can be further defined in FIG. 4A. The Message Set-up homescreen 404 may include a sender feature (implemented, e.g., via Sender buttons 420) that allows for a user to link to a screen to set up characteristics of the transaction with specific trading partners, such as sender identification, sender name, address, and other communication level information. Message Setup homescreen 404 may also include a modify feature for selectively modifying the message type identifier 424 and/or the corresponding ID criteria 416A-E. The modify feature may include a “Modify” button (or hyperlink, etc.) 428 that may, upon selection by a user, display a popup window (or another screen/page, etc.) (not shown) that allows the user to modify the corresponding message in an appropriate manner. Message setup homescreen 404 may further include an add feature for adding a message type to message type list 410. Such add feature may include an “Add Message Type” button 432 (or hyperlink, etc.) that may, upon selection by a user, display a popup window (not shown) (or another screen/page, etc.) that allows the user to add a new message type identifier 424 and appropriate ID criteria 416. Message setup homescreen 404 may also include a selector, such as “Finish” button 434, that a user may select when done with message match GUI 400.

Data match GUI 400 may include a match setup feature that allows a user to select which data field(s) within each record of incoming data 116 (FIG. 1A) and which data field(s) within each record of target data 108 DCU system 104 shall use in matching the incoming record(s) to the appropriate target record(s), if any, so that the proper target record(s) is/are retrieved and compared to the incoming record(s). For example, in the context of incoming data 116 being patient insurance eligibility data, it may be desirable to match and retrieve the appropriate target record(s) based on one or more fields of patient demographic data, e.g., a patient's name, social security number, date of birth and certificate number. The match setup feature may be initiated for each data type in data type list 410 by a corresponding respective “Match Setup” button 436 (or hyperlink, etc.) that initiates the display of Data Match Setup screen 406 (or popup window, dialog box, etc.) of FIG. 4B. FIG. 4B illustrates a match setup relative to the Eligibility Verification data type of the ASC X12 format illustrated in FIG. 4A, as identified in header 438 in Match Setup screen 406 of FIG. 4B.

Match Setup screen 406 illustrated in FIG. 4B may include a plurality of incoming data field selectors 440 (e.g., drop down menus) and a plurality of corresponding respective target data field selectors 442 (e.g., drop down menus) that allow a user to, respectively, select which data field(s) of incoming data 116 (FIG. 1A) and which data field(s) of target data 108 to use in matching and retrieving the correct target data. Each incoming data field selector 440 may display all or a subset of the fields appearing in incoming data 116, depending, e.g., on information known about the particular type of incoming message under consideration. A user would then use one or more of the incoming data selectors 440 to select the desired incoming data field(s) to be used in the retrieval of the appropriate fields (record, etc.) of target data 108 for comparison to incoming data 116. Target data field selectors 442 may work in a similar manner, but to allow a user to select which corresponding respective one(s) of the target data fields to use for retrieving the appropriate portion of target data 108.

Depending upon the configuration of target data 108 (FIG. 1A), i.e., how the target data is arranged into fields, records or other data constructs, Data Match Setup screen 406 of FIG. 4B may include a “Target Source” selector 444 (e.g., a drop-down menu) that allows a user to select a class of data which will present a subset of fields for data match module 204 that will appear in the drop-down menus of target data field selectors 442. For example, if target data 108 is patient data in hospital enterprise software, the data fields for each patient may include patient demographic fields, insurance fields, provider fields, clinical fields, etc. containing data corresponding to the respective field types. In the illustrated case, the target source 446 indicated is “Patient Demographic,” which indicates to data match module 204 that only patient demographic data fields are to be displayed in the drop-down menu of each target data field selector 442. Target Source selector 444 provides a means of narrowing the fields available for selection using target data field selectors 442, if such narrowing is needed. Of course, other embodiments need not include Target Source selector 444 or its associated functionality.

In some embodiments it may be desirable to provide data match module 204 with one or more features that allow a user to apply various matching rules to the matching that the data match module performs when receiving incoming data 116 recognized by DCU system 104. For example, at the field level, in some cases it may be desirable to match on entire first and last names of patients, whereas in other cases is may be desirable to match on only the first two or three letters of the first and last names. Consequently, data match setup screen 406 may include a rule selector 448, e.g., a drop-down menu, for each incoming data field selector 440 and target data field selector 442 pair that allows a user to select a desired rule for matching the corresponding incoming data and target data fields. In addition, it may also be desirable to implement higher-level matching rules, particularly when matching involves multiple pairs of incoming data and target data fields. For example, there may be a situation where matching is performed relative to four target data fields wherein two of the fields are such that only one of the fields is populated for any given patient and which field is populated as a function the value in a third one of the four fields. In this case, a rule may be applied that indicates to data match module 204 which of the two fields to look at based on the value in the third field. Data match setup screen 406 may include a rule selector 450, e.g., a drop-down menu, that allows a user to select an appropriate rule for the particular incoming data 116 under consideration.

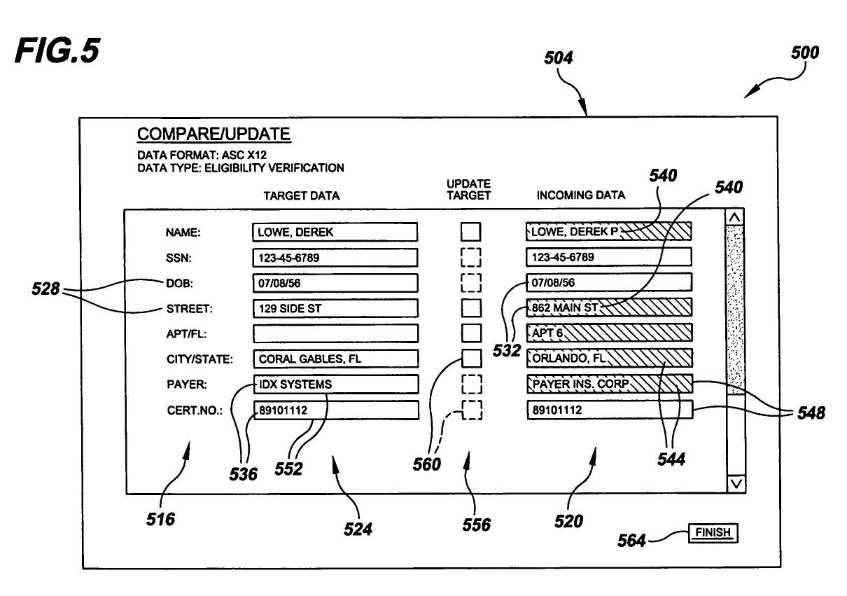

FIG. 4C illustrates Data Crossmap screen 408 that a user may access from Message Type Setup screen 404 of FIG. 4A, e.g., via a “Data Crossmap” button 452 (or hyperlink, etc.), to setup which fields of incoming data 116 (FIGS. 1A and 2) and target data 108 DCU system 104 will display (on COMPARE/UPDATE screen 504 of FIG. 5) and to setup how the system will allow a user to handle variant data. Data Crossmap screen 406 (FIG. 4B) may include a message type indicator 454 that indicates which type of message is under consideration. In the present example, message type indicator 454 is “Eligibility Results,” which indicates that the relevant fields at issue relate to patient demographic data and date corresponding to insurance eligibility. Data Crossmap screen 406 (FIG. 4B) may also include a field display region 456 that displays the names 458 of fields in incoming data 116, the names 460 of the corresponding respective fields of target data, and “Show Values” and “Allow Update” selectors, e.g., checkboxes 462, 464, that allow a user to select, respectively, which data field values DCU system 104 should display on COMPARE/UPDATE screen 504 (FIG. 5) when variant data is present in incoming data 116, and which incoming data values a user may select for updating the corresponding target data values. As will be seen below, the fact that Data Crossmap screen 406 (FIG. 4B) shows that a user has so far selected via checkboxes 462 field pairs LASTNAME.FIRSTNAME/NAME, MEMBERID/SSN, BIRTHDATE/DOB, and ADDRESSLN1/ADDR1 means that the data values contained in these fields will be displayed on COMPARE/UPDATE screen 504 of FIG. 5 during a compare/update session. In addition to Show Values and Allow Update checkboxes 462, 464, field display region 456 may include for each field pair a “Crossmap Definition” button 466 (or hyperlink, etc.) that allows a user to access a “Crossmap Definition” window 468 of FIG. 4D that permits a user to define for each field of incoming data 116 one or more relationships between that incoming field and field(s) of target data 108.

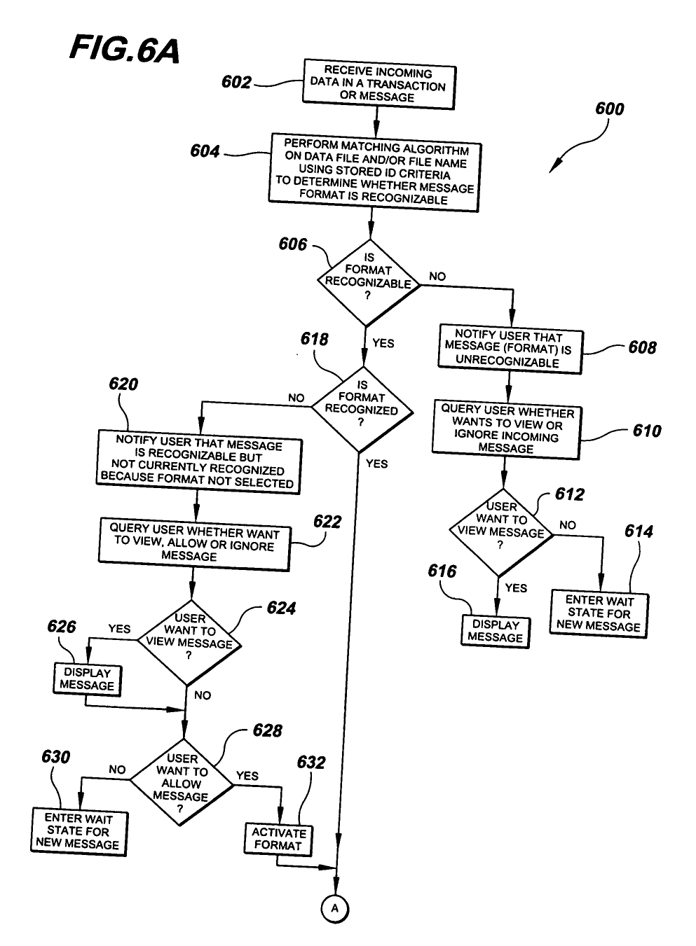

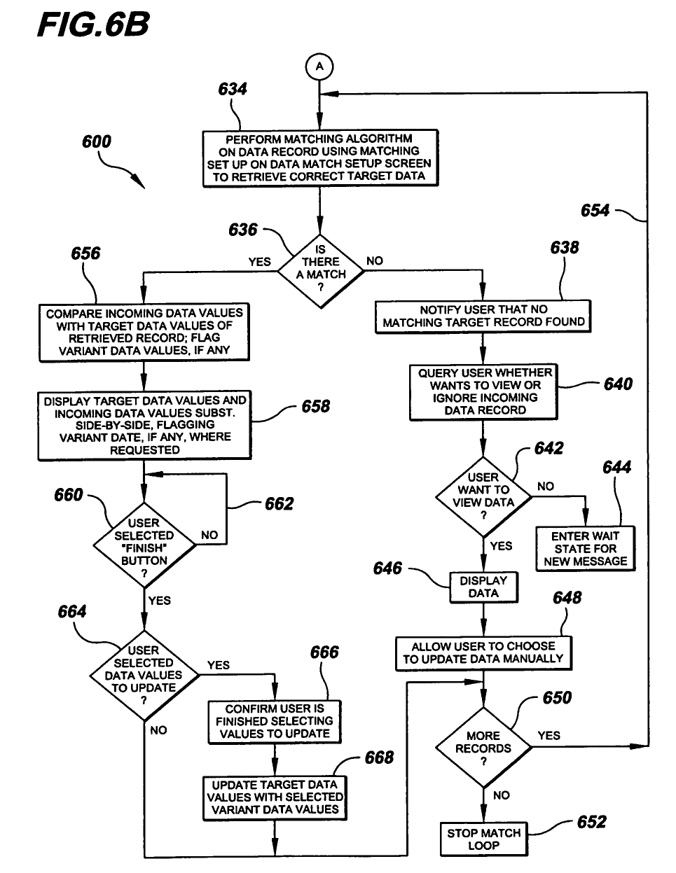

As shown particularly in FIG. 4D, Crossmap Definition window 468 may include an “Incoming Data Field” region 470; a “Compare Data To/Display Data From” region 472, an “Update Data To” region 474 and an “Add and Write to New Field” region 476. Incoming Data Field region 470 may display an incoming data field identifier 470A that identifies the current incoming data field selected for setting up the crossmap definition with one or more corresponding respective data fields of target data. Compare Data To/Display Data From region 472 allows a user to define which target data value will be compared to the incoming target value contained in the incoming data field identified by incoming data field identifier 470A of incoming field region. Generally, the user defines this target data value by selecting a particular field of target data 108 (FIG. 1A) using one or more target data selectors, depending upon the configuration of the target data. As discussed below in connection with COMPARE/UPDATE screen 504 of FIG. 5 and DCU method 600 of FIG. 6, the relevant target data value contained in the selected target data field will be displayed on the COMPARE/UPDATE screen if the user has chosen the incoming/target data field value pair to be displayed and there is indeed variant data in incoming data 116 (FIG. 1A) that the user has configured DCU system 104 (FIGS. 1A and 2) to identify.

To facilitate selection of an appropriate target data field, Compare Data To/Display Data From region 472 may include a “Target Datastore” selector 472A, a “Field” selector 472B and a field location region 472C. Target Datastore selector 472A and Field selector 472B may be, e.g., drop-down menus 472D, 472E that allow a user to first select the relevant datastore 112 (FIG. 1A) and then select the target data field of that datastore for which information will be displayed on COMPARE/UPDATE screen 504 of FIG. 5. Drop-down menu 472B may contain field names 472F of all of the target fields in the selected datastore 212. Upon selection of one of field names 472F, field location region 472C may display the location of the corresponding target field, e.g., by table name 472G and column name 472H, if the pertinent target datastore(s) 112 is/are so configured. The initial selection of a target datastore 112 using Target Datastore selector 472A, may implicate the use of a dictionary 256 (FIG. 2) for selection of a target data field via Field selector 472B. Dictionary 256 may contain information for the selected target datastore 112 that relates data field identifiers, field names 472F and table and column names 472G-H with one another.

In some cases it will be desirable to update multiple similar target data fields located in the same or different target datastores 112 (FIG. 1A) with the same incoming data value in incoming data 116. For example, if an incoming data value is a health certificate number and a particular healthcare entity stores the certificate number in a financial provider datastore and a healthcare plan datastore, it would be desirable to update both datastores with any new (and verified) certificate number in incoming data 116. Consequently, Update Data To region 474 may include multiple sets of “Target Datastore” selectors 474A, “Field” selectors 474B and field location regions 474C.

Each Target Datastore selector 474A and corresponding Field selector 474B and field location region 474C may work in a manner similar to Target Datastore selector 472A, Field selector 472B and field location region 472C of Compare Data To/Display Data From region 472. That is, each Field selector 474B and corresponding Datastore selector 474A may allow a user to select a particular target data field of a particular datastore 112 to update if the user has elected to allow such updating, as discussed above relative to FIG. 4C. If a user has not allowed updating to occur relative to a particular field of incoming data 116 (FIGS. 1A and 2), entire Update Data To region 474 may be deactivated and indicated as such by, e.g., “graying out” the entire region.

In this connection, it is noted that in addition to providing Show Values checkbox 462 and Allow Update checkbox 464 on setup screen 408 of FIG. 4C, crossmap definition window 468 may include duplicative Show Values and Allow Update checkboxes 478, 480 illustrated in FIG. 4D. These duplicative checkboxes 478, 480 allow a user to change the status of allowing the incoming/target data values to be displayed on COMPARE/UPDATE screen 504 (FIG. 5) and/or allowing updating without the need to switch back and forth between Crossmap Definition window 468 and Data Crossmap screen 408. Placing Show Values and Allow Update checkboxes 478, 480 on Crossmap Definition window 468 increases a user's convenience if, e.g., Update Data To region 474 is grayed out so as to indicate that updating of the value in the selected field is not permitted, and the user in fact wants to allow updating. In this case, the user can simply select Allow Update checkbox 480 so as to activate Update Data To region 474 and allow the user to select the corresponding target field(s) to be updated.

As discussed above, in some applications it may be desirable to compare a particular incoming data value to a particular target data value of a certain target data field and update a different target data field with that incoming data value. The alternate data field may be a closely related field or a totally unrelated field. An example of a closely related alternate field might be for Insurance Information that is usually stored in the Primary Insurance Field. If a new or different value for insurance is displayed from the incoming data, the new information may be stored in another location such as “Other Insurance.” An example of the need to update an unrelated field would be the case of a referral request that contains incoming approval information that is then compared to existing information regarding the dates of service. If the approved information shows a later date for the referral time period approved, the existing information may be updated to the new date and the existing referral status may be updated to “Extended.”

In most cases the new (i.e., not compared) target data field exists and will simply need to be selected from a list of existing data fields. In other cases it does not exist and needs to be created. In the latter cases, Add and Write to New Field region 476 allows a user to create the new target fields. To provide this functionality, Add and Write to New Field region 476 may include a “Field Definition” region 482 that allows a user to provide a new field name via a “New Field Name” input field 482A and define the location of the new field within target data 108 using one or more suitable “Field Location” input fields 482B, 482C depending upon how target data 108 is configured. In the present case, target data 108 is assumed to be arranged in tables. Consequently, Field definition region 482 may include “Table Name” input field 482B and “Column Name” input field 482C. In the event that the new target data field is located in a new table, Add and Write to New Field region 476 may include a “Define New Table” region 484 that allows a user to define a new table within target data 108. Defining a new table may include inputting a new table name using a “New Table Name” input field 484A and configuring the table, e.g., using a suitable table setup GUI (not shown) that may be accessible via a “Table Setup” selector 484B, e.g., button or hyperlink, etc. When the user is finished using Data Crossmap screen 406, the user may exit the screen using a suitable selector, such as “Finish” button 486.

C/U module 208 (FIG. 2) may include a user interface generator 244 that provides a C/U GUI, such as C/U GUI 500 illustrated in FIG. 5. As shown in FIG. 5, C/U GUI 500 may include a “COMPARE/UPDATE” screen 504 that is displayed during a compare and update session and at other times during use of DCU system 104. For example, COMPARE/UPDATE screen 504 may be the homescreen of DCU system 104 (FIGS. 1A and 2) that is displayed first each time the system is started. COMPARE/UPDATE screen 504 may also include a data field identifier region 516, an incoming data value display region 520 and a target data value display region 524, all displayed alongside one another to provide convenient viewing of the pertinent data field names and the corresponding values from both incoming data 116 and target data 108 for easy visual comparison by a user.

Data field identifier region 516 displays data field identifiers 528 corresponding to the data fields for which the data values are identified for display on Data Crossmap screen 408 (FIG. 4C) by the presence of checkmarks in the corresponding ones of Show Values selectors 462. In the present example, the data fields desired to be displayed are the data fields for the ASC X12 Eligibility Verification data type for an incoming 271 transaction. Correspondingly, incoming data value display region 520 displays the incoming data values 532 contained in incoming data 116 (FIGS. 1A and 2) for the indicated fields. Likewise, target data value display region 524 contains the target data values 536 for the indicated fields as retrieved from target datastore(s) 112 (FIG. 1A).

In addition to facilitating visual comparison of incoming data values 532 against target data values 536 by placing these values essentially side by side, C/U module 208 may be configured to visually flag variant data values 540, i.e., incoming data values that are not identical to the corresponding respective target data values 536. The visual flag(s) used to indicate variant data values 540 may be any of many types. In the present example, the visual flags are highlights 544 (shaded regions) in the incoming data value display areas 548 containing the variant data. Similar highlights (not shown) could also or alternatively be placed in the target data value display areas 552, if desired. Examples of other visual flags include a box or another shape that surrounds a variant data value, the bolding of the text of a variant data value, underlining of the text of a variant data value, the placing of an asterisk or other symbol adjacent a variant data value, etc. Implementing such visual indicators can greatly aid a user in recognizing variant data values, such as variant data values 540, and, hence, in more quickly deciding whether or not ones of target data values 536 should be updated, i.e., replaced, with the corresponding respective ones of incoming data values 532. It is noted that the term “replace” in this context is intended to cover the scenario in which either of target and incoming data values 536, 532 is a nullity, i.e., the corresponding data field is empty.

COMPARE/UPDATE screen 504 may also include an update selection region 556 containing selectors, e.g., checkboxes 560, that allow a user to select the one(s) of variant data values 540, if any, that should be used to update the corresponding respective target data value(s) 536 as stored in one or more of target datastores 112 (FIG. 1A). If a user desires that one or more target data values 536 should be updated, the user would select the checkbox(es) adjacent the corresponding incoming data value(s). Then, after finishing the selection process, the user may select a “Finish” button 564 (or hyperlink, etc.) that may trigger a popup menu (not shown) to appear. The popup menu may display a message “Do you want to update the target data values now?” or the like, and contain corresponding “Yes” and “No” buttons that control the next step. If the user selects the Yes button, C/U module 208 would update the appropriate target datastore(s) 112 with the selected incoming data values 532. On the other hand, if the user selects the No button, the popup window would disappear and COMPARE/UPDATE screen 504 would again become active. Those skilled in the art will appreciate that while checkboxes 560 are shown and described, other selection features may readily be implemented in the alternative. For example, the selection feature may include selecting the data field identifier 528, target data value 536 or the variant data value 540 for each target value desired to be updated by clicking on that item. Upon clicking on an item, user interface generator 244 may highlight that item, e.g., with a highlight, perhaps of a color or shade different from highlights 544 to distinguish the two types of highlights.

Generally, the presence of modules 200, 204, 208 (FIG. 2) provides DCU system 104 with a wide range of flexibility that essentially allows DCU system 104 to be implemented as, e.g., a standalone computer application, and to be configured to handle incoming data of virtually any data format and data type and that contains any number or data formats and data types. It will be readily appreciated, however, that a DCU system of the present invention need not be provided with all of this functionality. Rather, only the functionality that is needed for a particular application need be provided. For example, if a DCU system of the present invention does not need to be configurable to be usable with a variety of target datastores, that DCU system may not need target datastore selectors 472A, 474A of Crossmap Definition window 468. This may be the case, e.g., where the DCU system is not a standalone computer application, but rather is integrated into another computer application, e.g., an insurance eligibility verification application, such as the eligibility verification application of the FLOWCAST® healthcare information technology solution available from IDX Systems Corporation, Burlington, Vt., or is a standalone application preconfigured for interfacing with only a single known target datastore. Similarly, if it is known that a DCU system of the present invention is going to be used for incoming data having only a single known format, that system may be designed without data format ID module 200. Consequently, those skilled in the art will readily appreciate that a wide variety of DCU systems falling within the scope of the present invention may be readily designed and implemented in a variety of implementations.

FIGS. 6A-B illustrate a DCU method 600 of the present invention that may be performed by DCU system 104 of FIGS. 1A and 2 or other DCU system made in accordance with the present invention. For convenience, DCU method 600 is illustrated in connection with DCU system 104. Consequently, reference will be made to FIGS. 1-5 in describing DCU method 600. To aid in referencing the drawings, it is noted that the first digit of each element numeral corresponds to the figure number containing that element. Generally, the only exception is that some “100”-series numerals appear in FIG. 2, as well as in FIG. 1. DCU method 600 may be considered to begin at step 602 when DCU system 104 receives incoming data 116, typically in a transaction or, more generically, message. After receiving the incoming message, at step 604 message format ID module 200 may perform a matching algorithm on incoming message 116 and/or the filename of the file containing the incoming message to determine whether the format of the message in the file is recognizable. The matching algorithm may be any suitable character, string, text or other matching algorithm, conventional or otherwise.

At step 606, if message ID module 200 determines that the message format is not recognizable, i.e., the message format has not been entered into the message format ID module, at step 608 the message ID module 200 may notify the user that the message (format) is unrecognizable and may further query the user at step 610 as to whether the user wants to view or ignore the incoming message. If it is determined at step 612 that the user does not want to view the incoming data, at step 614 DCU system 104 may enter a wait state that waits for new incoming message or a user action, such as navigate to any one of the various GUIs of the system, such as format ID GUI 300 or message match GUI 400. However, if at step 612 it is determined that the user wants to view the unrecognizable message, e.g. via the user selecting an appropriate button or other selector, message format ID module 200 may at step 616 display the incoming message, e.g., so that the user may visually determine whether or not the message is of the type that DCU system 104 should be configured to handle. In conjunction with the display of the incoming message, DCU system 104 may provide a feature (not illustrated) that allows the user to enter the message format and message type information for incoming message 116 and information relating to target message 108 into the system so that the system can recognize and process the message. DCU system 104 may utilize a buffer 264 or other storage means that stores incoming message 116 so that once the user has correctly configured the system to recognize and handle the new message format and type, the message is available for processing. That said, if the user does not want the message to be recognized and processed, DCU system 104 may provide the user with the option to simply ignore the message.

If at step 606 message ID module 200 determines that the format of the incoming message containing incoming data 116 is recognizable using a suitable matching algorithm, at step 618 the message ID module may determine whether or not the format is recognized, i.e., if the format has been entered into the DCU system 104 and is currently active. Message ID module 200 may determine the active state of the format at issue by determining whether or not the checkbox 312 in Message Format Setup homescreen 304 contains a checkmark. If the message format is not active, at step 620, message ID module 200 may notify the user that the message (format) is recognizable, but not currently recognized because it is not active. At step 622, message ID module 200 may query the user as to whether the user wants to view the message, allow the message or ignore the message. If, at step 624 message ID module 200 determines that the user wants to view the incoming message, e.g., by selection of an appropriate button or other selector, the message ID module may display the message.

Regardless of whether or not the user wants to view incoming message at step 626, at step 628 message ID module 200 may determine whether or not the user wants to allow the incoming message to be processed. This may be accomplished by provided any message viewing screen (not shown) or dialog box (not shown) with one or more buttons or other selectors that allows the user to make an appropriate selection. If message ID module 200 determines that the user does not want to allow incoming message, then at step 630 DCU system 104 may enter a wait state that waits for a new incoming message or a user action, such as navigate to any one of the various GUIs of the system. However, if at step 628 it is determined that the user wants to view the unrecognized message, message ID module 200 may at step 632 activate the format so that DCU system 104 may further process the incoming message.

If at step 618 message ID module 200 determined that incoming message 116 is recognized or, alternatively, at step 632 that the user activated the format, method 600 may proceed to step 634. At step 634, data match module 204 may perform a matching algorithm on a first record of incoming data 116 using the matching criteria set up on Data Match Setup screen 406 to determine whether there is a matching data record in target data 108. The matching algorithm may be based on any suitable criteria or rule setup. At step 636, if data match module 204 determines that the first data record of incoming data 116 is not matched i.e., the incoming data record has not been matched to a corresponding respective data record in target data 108, at step 638 data match module 204 may notify the user that it has not found a matching target data record for the particular incoming data record at issue. At step 640, data match module 204 may further query the user at as to whether the user wants to view or ignore the incoming data record.

If it is determined by data match module 204 at step 642 that the user does not want to view the incoming data record, at step 644 DCU system 104 may enter a wait state that waits for a new record incoming data 116 or a user action, such as navigation to any one of the various GUIs of the system. However, if at step 642 DCU system 104 determines that the user wants to view the unmatched data record, e.g. via the user selecting an appropriate button or other selector, data match module 204 may at step 646 display incoming data record 116, e.g., so that the user may visually determine whether or not the data record can be matched. In conjunction with the display of incoming data record 116, DCU system 104 may at step 648 allow a user to choose to match the incoming record manually and allow the system to process the data record. As mentioned above, DCU system 104 may utilize buffer 264 or other storage means that stores the incoming data record so that once the user has correctly matched the new incoming data record, the data record is available for processing. That said, if the user does not want the data record to be matched, DCU system 104 may provide the user with the option to simply ignore the data record. At step 650 DCU system 104 may determine whether or not more records are contained in incoming data 116. If so, DCU method may loop back to step 634 to match on the next incoming record so as to retrieve a corresponding record from target data 108. If, on the other hand, there are no more incoming records, DCU method 600 may proceed to step 652 in which the matching loop 654 is not continued.

If at step 636 data match module 204 determines that the type of incoming data 116 is matched, it may proceed to step 656 at which C/U module 208 may compare data values of incoming data 116 with corresponding respective data values of target data 108 of the pertinent records for the data values selected on Data Crossmap screen 408 (FIG. 4C). At this step, C/U module 208 may also flag variant data values 540 contained in incoming data 116, if any. At step 658, C/U module 208 may display on COMPARE/UPDATE screen 504 in substantially a side-by-side-by-side fashion field identifiers 528, target data values 536 and incoming data values 532, which includes any variant data values 540. At step 658, C/U module 208 may also flag, e.g., highlight, variant data values 540, if any, to aid a user in quickly identifying variant data. As discussed above, a user may select which variant data values 540 to flag. C/U module 208 may also display or activate any update checkboxes 560 on COMPARE/UPDATE screen 504 that a user has designated as being active (see description of Allow Update selectors 464, 480 above) so that a user may initiate the updating of target data values 536 with corresponding respective variant data values 540.

At step 660, DCU system 104 may determine whether or not a user has finished viewing COMPARE/UPDATE screen 504 and/or selecting variant data values 540 for updating. DCU system 104 may make this determination by polling a Finish button 564 on C/U screen 504. If DCU system 104 determines that the user is not finished, DCU method 600 may simply enter a loop 662 that causes the system to wait until it determines the user is finished. However, if at step 660 DCU system 104 determines that the user has finished, at step 664 C/U module 208 may determine whether or not the user has selected any variant data values 540 to replace the corresponding respective target data values 536. C/U module 208 may make this determination simply by recognizing whether or not any of checkboxes 560 on C/U screen are checked. If at step 664, C/U module 208 determines that the user has not selected any variant data values 540 for updating, the module may display a dialog box (not shown) asking the user to confirm that the user would like to finish without making any selections. Of course, C/U module 208 would display such a dialog box only when there is variant data values for updating. After displaying such a dialog box and receiving a user response, DCU method 600 may proceed to step 650 wherein DCU system 104 may determine whether or not incoming data 116 contains any more records to process.

If, on the other hand, C/U module 208 determines at step 664 that the user has selected variant data values 540 for updating, at step 666 C/U module 208 may confirm, e.g., via a dialog box (not shown) that the user has indeed selected all of the values desired to be updated. After the user has made such confirmation, at step 668 C/U module 208 may update the appropriate target data values 536 with the corresponding respective variant data values 540. After updating at step 668, DCU method 600 may proceed to step 650 wherein DCU system 104 may determine whether or not incoming data 116 contains any more records to process.

Although the invention has been described and illustrated with respect to an exemplary embodiment thereof, it should be understood by those skilled in the art that the foregoing and various other changes, omissions and additions may be made therein and thereto, without parting from the spirit and scope of the present invention.

What is claimed is:

1. A method of facilitating visual comparison of a plurality of incoming data values with a plurality of target data values, the plurality of incoming data values respectively associated with a plurality of incoming data fields and the plurality of target data values respectively associated with a plurality of target data fields and stored in at least one target datastore, the method comprising:
a) receiving via a first user interface a selection of at least one incoming data field of the plurality of incoming data fields;
b) retrieving from the at least one target datastore the plurality of target data values as a function of said at least one incoming data field selected; and
c) displaying the plurality of target data values and said plurality of incoming data values simultaneously with one another on a display so as to facilitate visual comparison of the plurality of target data values and said plurality of incoming data values.

2. A method according to claim 1, wherein the incoming data values are contained in a file having a data format and the method further comprises receiving via a second user interface an identification of said data format.

3. A method according to claim 2, further comprising displaying on said display a plurality of data format identifiers and receiving a user-selection of at least one of said plurality of data format identifiers corresponding to said data format.

4. A method according to claim 1, wherein the incoming data values are associated with at least one data type and the method further comprises receiving via a third user interface an identification of said at least one data type.

5. A method according to claim 4, further comprising displaying on said display a plurality of data type identifiers and receiving a user-selection of at least one of said plurality of data type identifiers corresponding to said at least one data type.

6. A method according to claim 1, further comprising comparing corresponding respective ones of the plurality of target data values and the plurality of incoming data values with one another so as to determine whether or not any of the plurality of incoming data values are variant data values relative to the plurality of target data values.

7. A method according to claim 6, further comprising displaying on said display a variant data flag for at least some of said variant data values.

8. A method according to claim 7, further comprising displaying an update selector for at least one said variant data value, said update selector operatively configured to, in response to being selected, update a corresponding respective one of the plurality of target data values with said at least one said variant data value.

9. A method according to claim 1, further comprising displaying a first user interface configured to permit a user to cross-map ones of the plurality of incoming data fields to ones of the plurality of target data fields.

10. A method according to claim 1, further comprising displaying a second user interface configured to permit a user to select ones of the plurality of incoming data fields for which variant data values therein are flagged on said display.

11. A method according to claim 1, further comprising displaying a third user interface configured to permit a user to select ones of said plurality of incoming data fields for which variant data update selectors are displayed on said display.

12. A computer-readable medium containing computer-executable instructions for performing a method of facilitating visual comparison of a plurality of incoming data values with a plurality of target data values, the plurality of incoming data values respectively associated with a plurality of incoming data fields and the plurality of target data values respectively associated with a plurality of target data fields and stored in at least one target datastore, the computer-executable instructions comprising:
a) a first set of computer-executable instructions for receiving via a first user interface a selection of at least one incoming data field of the plurality of incoming data fields;
b) a second set of computer-executable instructions for retrieving from the at least one target datastore the plurality of target data values as a function of said at least one incoming data field selected; and
c) a third set of computer-executable instructions for displaying the plurality of target data values and said plurality of incoming data values simultaneously with one another on a display so as to facilitate visual comparison of the plurality of target data values and said plurality of incoming data values.

13. A computer-readable medium according to claim 12, wherein the incoming data values are contained in a file having a data format and the computer-executable instructions further comprise computer-executable instructions for receiving via a second user interface an identification of said data format.

14. A computer-readable medium according to claim 13, further comprising computer executable instructions for displaying on said display a plurality of data format identifiers and for receiving a user-selection of at least one of said plurality of data format identifiers corresponding to said data format.

15. A computer-readable medium according to claim 12, wherein the incoming data values are associated with at least one data type and the computer-executable instructions further comprise computer-executable instructions for receiving via a third user interface an identification of said at least one data type.

16. A computer-readable medium according to claim 15, further comprising computer-executable instructions for displaying on said display a plurality of data type identifiers and for receiving a user-selection of at least one of said plurality of data type identifiers corresponding to said at least one data type.

17. A computer-readable medium according to claim 12, further comprising computer-executable instructions for comparing corresponding respective ones of the plurality of target data values and the plurality of incoming data values with one another so as to determine whether or not any of the plurality of incoming data values are variant data values relative to the plurality of target data values.

18. A computer-readable medium according to claim 17, further comprising computer-executable instructions for displaying on said display a variant data flag for at least some of said variant data values.

19. A computer-readable medium according to claim 18, further comprising computer-executable instructions for displaying an update selector for at least one said variant data value, said update selector operatively configured to, in response to being selected, update a corresponding respective one of the plurality of target data values with said at least one said variant data value.

20. A computer-readable medium according to claim 12, further comprising computer-executable instructions for displaying a first user interface configured to permit a user to cross-map ones of the plurality of incoming data fields to ones of the plurality of target data fields.

21. A computer-readable medium according to claim 12, further comprising computer-executable instructions for displaying a second user interface configured to permit a user to select ones of the plurality of incoming data fields for which variant data values therein are flagged on said display.

22. A computer-readable medium according to claim 12, further comprising computer-executable instructions for displaying a third user interface configured to permit a user to select ones of said plurality of incoming data fields for which variant data update selectors are displayed on said display.

23. A system facilitating visual comparison of a plurality of incoming data values to a corresponding respective plurality of target data values, the plurality of incoming data values associated respectively with a plurality of incoming data fields and the plurality of target data values associated respectively with a plurality of target data fields, the system comprising:
a) a first means for displaying the plurality of target data values and the plurality of incoming data values substantially side-by-side so as to facilitate visual comparison of like ones of the plurality of incoming data values and the plurality of target data values; and
b) a second means for allowing a user to select at least one of the plurality of incoming data fields and for utilizing the selected one of said plurality of incoming data fields to retrieve the plurality of target data values.

24. A system according to claim 23, wherein said first means is further for visually flagging variant data values among the plurality of incoming data values and the plurality of target data values.

25. A system according to claim 24, wherein said first means is further for displaying at least one update selector that allows a user to select at least one of said variant data values for updating a corresponding respective one of the plurality of target data values.

26. A system according to claim 23, wherein the plurality of incoming data values are contained in a file having a data format, the system further comprising a third means for allowing a user to configure the system to recognize said data format.

27. A system according to claim 23, wherein the plurality of incoming data values are contained in a file having a data format, the system further comprising a fourth means for allowing a user to select said data format from among a plurality of data formats.

28. A system according to claim 23, wherein the plurality of incoming data values correspond to at least one data type, the system further comprising a fifth means for allowing a user to configure the system to recognize said at least one data type.

29. A system according to claim 23, wherein the plurality of incoming data values correspond to at least one data type, the system further comprising a sixth means for allowing a user to select said data type from among a plurality of data types.
